(19) United States
(12) Patent Application Publication
(10) Pub. No.: US 2005/0252503 A1
(43) Pub. Date: Nov. 17, 2005

(54) Translucent or opaque colored glass-ceramic article providing a cooking surface and its use

(76) Inventors: Friedrich Siebers, Nierstein (DE); Ulrich Schiffner, Mainz (DE); Otmar Becker, Langen (DE); Wolfgang Schmidbauer, Mainz (DE); Ioannis Kosmas, Stadecken-Elsheim (DE); Erich Rodek, Mainz (DE); Reiner Best, Albig (DE)

Correspondence Address: STRIKER, STRIKER & STENBY, 103 EAST NECK ROAD, HUNTINGTON, NY, 11743, US

(21) Appl. No.: 11/124,853

(22) Filed: May 9, 2005

(30) Foreign Application Priority Data
May 12, 2004 (DE) 10 2004 024 583.5

(51) Int. Cl. C03C 10/14; B32B 17/06

(52) U.S. Cl. 126/1 R; 501/4; 428/432; 428/426

(57) ABSTRACT

The translucent or opaque colored glass-ceramic article provides a cooking surface and has an adjustable light transmission in a visible range under 15%, as measured for a 4 mm sample thickness; a flaw-free upper surface with an impact resistance of greater than 18 cm breaking height, as tested with a 200 g steel ball in a falling ball test; a temperature difference resistance of greater than 500° C.; a high crystallinity with keatite mixed crystals as principal crystal phase in an interior of the glass-ceramic article and with a residual glass phase fraction of less than 8% by weight; a glassy upper surface layer of from 0.5 to 2.5 μm thick, which is substantially free of high quartz mixed crystals and which inhibits chemical reactions, and a content of enriched ingredients in the residual glass phase in the interior of the glass-ceramic and in the glassy surface layer of ΣNa₂O+K₂O+CaO+SrO+BaO+F+refining agents of from 0.2 to 1.6% by weight.

### BACKGROUND OF THE INVENTION

1. Field of the Invention

The present invention relates to a translucent or opaque colored glass-ceramic article providing a cooking surface and its use.

2. Related Art

It is known that glasses from the Li₂O—Al₂O₃—SiO₂ system may be converted into glass-ceramic articles with high quartz mixed crystals and/or keatite mixed crystals as principal crystal phases. The making of these glass-ceramics occurs in several stages. After melting and hot shaping the glass is usually cooled to temperatures in the region of the transformation temperature (Tg), in order to remove thermal stresses. After that the material is further cooled to room temperature.

The starting glass is crystallized with a second controlled temperature treatment and converted into a glass-ceramic article. This ceramicizing occurs in a multi-stage temperature process, in which crystal nuclei are produced by nuclei formation at a temperature from 600 to 800° C., usually from TiO₂ or ZrO₂/TiO₂ mixed crystals. Also SnO₂ can participate in the nuclei formation process. High quartz mixed crystals grow from these nuclei during heating at crystallization temperatures from about 700 to 900° C. Because of the small crystal sizes of less than 100 nm optically transparent glass-ceramics are produced, which have a high quartz mixed crystal phase. Translucent glass-ceramics may be produced by reducing the nuclei-forming content and larger crystal sizes.

The high quartz mixed crystals convert further to keatite mixed crystals during further heating in a range from about 850° C. to 1200° C. The temperature for this structural phase change is dependent on the composition. The conversion to keatite mixed crystals is connected with crystal growth, i.e. increasing crystallite size, whereby increasing light scattering occurs, i.e. light transmission is increasingly reduced. The glass-ceramic article appears increasingly translucent because of that and eventually becomes opaque.

A key property of the glass-ceramics made from the Li₂O—Al₂O₃—SiO₂ system is the manufacturability of materials, which have a best low thermal expansion coefficient in a range from room temperature to 700° C. of below 1.5×10 ⁻⁶ K⁻¹ for materials with keatite mixed crystals as principal crystal phase in addition to the residual glass phase. Glass-ceramics, which contain high quartz mixed crystals as principal crystal phase, are materials with a thermal expansion coefficient of less than 0.3×10⁻⁶ K⁻¹ even in this temperature range, thus a nearly zero thermal expansion. Because of the low thermal expansion these glass-ceramics have outstanding temperature difference resistance and temperature change resistance.

Transparent glass-ceramics with high quartz mixed crystals as the principal crystal phase find application, e.g. in fire resistant glass, chimney windows, reflectors in digital protection units (beamers) or as cooking vessels. For application as cooking surfaces a reduction of light transmission to values under 15% is required, in order to avoid observation of the apparatus under the cooking surface (e.g. with induction cooking surfaces) and to reduce the light radiation from radiating bodies, halogen heated bodies and glass burners to the desired values. This lowering of the light transmission is achieved, e.g. by coloring transparent glass-ceramics with colored metal oxides and by glass-ceramics, which are converted to be translucent or opaque.

Glass-ceramics with high quartz mixed crystals as the predominant crystal phase are most widely used for cooking surfaces. Because of its low thermal expansion coefficient of less than 0.3×10⁻⁶ K⁻¹ between room temperature and 700° C. these glass-ceramics have an outstanding temperature difference resistance (TUF) of greater than 800° C., which satisfies all requirements for a cooking surface.

The small thermal conductivity of the glass-ceramic article of about 1.5 W/mK guarantees that the temperatures near the cooking zones drop off rapidly and the edges remain cold. This is desirable due to safety and energy-saving considerations.

The light transmission of these known glass-ceramic articles is adjusted to about 0.5 to 3% by addition of coloring ingredients, in order to avoid viewing the built-in structures under the cooking surface and to guarantee protection from being dazzled by the radiating or halogen heating bodies. V₂O₅ is primarily used as a coloring ingredient in modern glass-ceramic articles for cooking units, because it has the special properties that it absorbs visible light, but has a high transmission in the infrared region of the spectrum. The high transmission in the infrared is advantageous because the radiation directly reaches the bottom of a cooking vessel on the cooking surface, is absorbed there and thus rapidly cooks the contents of the cooking vessel. However although V₂O₅ or other coloring oxides, such as CoO, NiO or Fe₂O₃ are used, the cooking surface appears black because of the low light transmission. The different coloring oxides differ only in the color of the glowing heating body, when the cooking vessel is not on the cooking zone above it.

The colors are very limited because of that and differences are very difficult to achieve by design. In order to help overcome this difficulty different references have proposed the use of decorative paints on the surface. However this method does not change the glass-ceramic material itself and only produces a partial effect.

Cooking surfaces of glass-ceramic with keatite mixed crystals as the predominant crystal phase have up to now found no wide spread application, because there is a thermal expansion coefficient increase when a high quartz mixed crystal glass-ceramic is converted into a keatite mixed crystal glass-ceramic. The thermal expansion coefficient between 20 and 700° C. increases to a value of α, which is mainly above 1.0×10⁻⁶ K⁻¹. Especially good melting and devitrification resistant compositions are available with high thermal expansion coefficients. However no sufficient temperature difference resistance may be obtained for modern cooking surface systems, which have heating bodies of high power, with these compositions.

The temperature difference resistance, ΔT, of the glass ceramic is given by the following equation (1):

$$Δ T = ( \frac{1}{f} ) \cdot [ \frac{{σ}_{g} ( 1 - μ )}{α - E} ] , \qquad ( 1 )$$

wherein f is a dimensionless correction factor (based on the plate geometry and the temperature distribution), μ is the Poisson number, α is the thermal expansion coefficient, E is the elasticity modulus and σ_{g} is the breaking strength of the material, which in practical applications is adjusted according to the surface damage. Since both the thermal expansion coefficient and also the E-modulus increase on conversion of high quartz to keatite mixed crystals glass-ceramic, the troublesome temperature difference resistance is a principal disadvantage of the material, which stands in the way of a long service life for modern cooking surface systems.

EP 1170264 B1 describes a glass-ceramic with keatite mixed crystals as the predominant crystal phase in the interior of the glass-ceramic and high quartz mixed crystals as the further crystal phase in a surface layer of the glass-ceramic. Because the thermal expansion coefficient of the high quartz mixed crystals is smaller than that of the keatite mixed crystals compressive stresses are produced, which counteract the strength-reducing surface damage that occurs during usage. The temperature difference resistance is raised to values above 650° C. because of that. The properties of these translucent glass-ceramics are sufficient for cooking surface applications. However the presence of high quartz mixed crystals in the surface of the glass-ceramic has the disadvantage that the SiO₂ content of the high quartz mixed crystals is raised to values over 80% by weight at higher conversion temperatures and longer conversion times. An undesirable conversion of the high quartz mixed crystal phase to an α-quartz mixed crystal phase, which leads to cracks or fractures in the surface of the glass-ceramic, occurs on cooling of the glass-ceramic to room temperature. Because of that the impact resistance is reduced to values, which are insufficient for cooking surface applications. The limits for the conversion temperature and time ranges, which result from that, have disadvantages for color design, since the color shades can only be varied within a very narrow range.

U.S. Pat. No. 4,211,820 discloses a substantially transparent glass-ceramic with increased breaking strength and lighter opacity, which corresponds to a higher transmission in the visible. The transparent glass-ceramic is colored brown by means of from 0.02 to 0.2% by weight V₂O₅. A comparable glass-ceramic with keatite mixed crystals in the interior and high quartz mixed crystals on the surface is also known from U.S. Pat. No. 4,218,512. Herein similarly only a light opacity is observed. A light transmission below 15%, as required for cooking surfaces, is not disclosed. The adjustment of the phase separation for improving the strength requires an exact control of the conversion temperature and conversion time. This is disadvantageous e.g. for design of glass ceramics of various colors.

WO 99/06334 discloses a translucent glass-ceramic, which has an opacity degree of at least 50%. Furthermore WO 99/06334 describes a corresponding glass-ceramic with a transmission in the visible range of 5 to 40%. The named translucent glass-ceramic neither contains keatite mixed crystals as the predominant crystal phase nor exclusively keatite mixed crystals as a single crystal phase. No suggestions are given for increasing the temperature difference resistance and the chemical resistance, which are advantageous for modern cooking surfaces. Also methods of color design, which are required to obtain certain color changes, are not described.

EP 0 437 228 B2 describes a transparent glass-ceramic with high quartz mixed crystals as predominant crystal phase or a white opaque glass-ceramic with keatite mixed crystals as the principal crystal phase. Glass-ceramics with variable translucency or opacity are not described.

The variably translucent glass-ceramic described in EP 536 478 A1 contains regions with keatite/gahnite mixed crystals besides regions with high quartz mixed crystals. These gahnite mixed crystals (ZnO.Al₂O₃) arise during phase transformation of high quartz mixed crystals to keatite mixed crystals and compensate the density change connected with this phase transformation. Because of that transparent, translucent and opaque regions exist next to each other in the glass-ceramic article. Keatite mixed crystals are the principal crystal phase in the translucent and opaque regions. Gahnite crystals have a substantially higher thermal expansion coefficient than that of the above-mentioned mixed crystal phases (high quartz and/or keatite) of typical LAS glass-ceramics. Disadvantages with the temperature difference resistance are to be expected as well as premature cracks and fractures in the lattice and thus poor impact resistance because of different thermal expansion characteristics.

### SUMMARY OF THE INVENTION

It is an object of the present invention to provide glass-ceramic articles having many different and various appearances.

According to the invention the translucent or opaque colored glass-ceramic article has
an adjustably variable light transmission in a visible range under 15%, as measured for a 4 mm sample thickness;
a crack-free or flaw-free upper surface with an impact resistance of greater than 18 cm breaking height, as tested with a 200 g steel ball in a falling ball test;
a temperature difference resistance, TUF, of greater than 500° C., preferably greater than 700° C.;
a high crystallinity with keatite mixed crystals as principal crystal phase in an interior of the glass-ceramic article and with a residual glass phase fraction of less than 8% by weight;
a glassy surface layer, which is substantially free of high quartz mixed crystals, from 0.5 to 2.5 μm thick and which inhibits chemical reactions; and
a content of enriched ingredients in the residual glass phase in the interior of the glass-ceramic and in the glassy surface layer of ΣNa₂O+K₂O+CaO+SrO+BaO+F+refining agents of from 0.2 to 1.6% by weight.

Because of the main crystal phase comprising keatite mixed crystals it is possible to prepare the desired translucent or opaque glass-ceramic articles with the cooking surfaces in arbitrary shades, when e.g. one selects the crystallite size. Additional color effects can be achieved for example by addition of colored additives. The use of these glass-ceramic articles to provide cooking surfaces is unobjectionable, especially because of the high impact resistance, the passivating surface glass layer and the high temperature difference resistance.

During manufacture of the glass-ceramic article providing the cooking surface the required plate-shaped geometry is produced when the glass is conducted through a drawing nozzle of noble metal and pressed between two shaping rolls, cooled and thus shaped. The upper roll, which shapes the cooking surface, is smooth so that it produces a smooth cooking surface, but the lower roll is structured and produces a knobbed surface. The knobs are advantageous for promoting the impact resistance or strength, because they protect the glass surface from damage during further manufacturing processes, e.g. by conveyor rollers or ceramic supports. Downstream of the shaping rolls the glass sheet is conducted over transport rollers into the cooling oven and stresses in the glass are relieved. Glass plates at the end of the cooled sheet are cut off in the desired geometry. A quality control test then takes place e.g. to find surface defects and bubbles. The edges of the glass plates are worked. The plates are decorated prior to ceramicizing, when the decorative paints are burned in during the ceramicizing. Otherwise the decorative paints are burned in during subsequent temperature treatments.

The temperature difference resistance is an indispensable property for a glass-ceramic article providing a cooking surface. The cooking surface material in the vicinity of the cooking zones is strongly heated according to the type of heating. The maximum temperatures amount to about 500° C. for cooking surfaces with induction heating or gas burners. However the material in the vicinity of the cooking zones is heated to higher temperatures when powerful halogen heating bodies or radiant heating bodies are used. These temperatures are desired in order to guarantee rapid cooking. Of course temperature limiters control the heating body when too high temperatures, i.e. above about 560° C., are reached. However during inappropriate operation, for example when a cooking vessel is empty or only partially covers a cooking zone, temperatures on the glass-ceramic cooking surface can reach about 700° C. Because of the combination of hotter cooking zones and colder surroundings glass-ceramic articles having a temperature difference resistance at 500° C. are suitable for induction cooking surfaces, while glass-ceramic articles having a temperature difference resistance of about 700° C. are suitable for radiantly heated cooking surfaces.

Translucent or opaque cooking surfaces, which contain keatite mixed crystals as the predominant crystal phase, offer many possibilities for color design. Light scattering occurs because of the larger crystallite size of the keatite mixed crystals. Translucence and/or opacity and because of that even the whiteness impression are variably adjustable depending on crystallite size. Without addition of coloring ingredients coloring mechanisms are based on light scattering alone so that the cooking surface appears white-translucent or white-opaque. The color impression is produced by a combination of light scattering and absorption in the glass-ceramic material when coloring components, such as e.g. V₂O₅, CoO, NiO, are added. Many different color design possibilities result from the selection of coloring ingredients and adjustment of the crystallite size during conversion of the glass-ceramic. The color impression of the cooking surface may be optimally adjusted to the desired unit design. It is especially advantageous that one and the same composition, with addition of coloring components as needed, may produce many different color shades in an economical manner by control of the conversion conditions (temperature, time). A cooking surface having an intense white shape is produced with increasing conversion temperature and time. Other important properties, which a cooking surface should have, such as impact resistance, temperature difference resistance and chemical resistance, are not impaired.

Reduction of the light transmission to values under 15% can be achieved by the glass-ceramic substrate alone or in combination with a light-absorbing coating or layer. The coating can be applied to the upper and lower surfaces of the glass-ceramic article providing the cooking surface.

The safe use of the glass-ceramic providing the cooking surface presupposes that the impact resistance satisfies the requirements. Simulation calculations for a plate-shaped translucent glass-ceramic with finite-difference methods show that tangential tensile stresses arise in certain applications at the plate outer edges, which are near the cooking zones. Surface conditions with compressive stress, which has a high strength σ_{g} even after damage due to usage, arise in the glass-ceramic articles providing the cooking surfaces according to the invention.

Glass-ceramics with keatite mixed crystals as principal crystal phase contain a residual glass phase within its lattice. Compositions, such as Na₂O, K₂O , CaO, BaO and refining agents, which are not built into the crystals, are enriched in the residual glass phase. These components are advantageous for meltability and devitrification resistance during shaping or molding. However it has been shown that the temperature difference resistance suffers, especially with too high a residual glass phase proportion. On account of this the amount of the residual glass phase is limited to under about 8% by weight, preferably under about 6% by weight.

In order to protect glass-ceramic cooking surface from chemical attack, an approximately 0.5 to 2.5 μm thick glassy coating is provided on the immediate upper surface. The ingredients, which are not built into the high quartz mixed crystal phase, e.g. the alkali oxides Na₂O, K₂O and alkaline earth oxides, such as Cao, SrO, BaO and the refining agents, are enriched in this glassy coating. The glassy surface layer protects the lithium-containing mixed crystals from attack by acid or alkali and should be at least 0.5 μm thick. Greater thickness than 2.5 μm is to be avoided, because the higher thermal expansion coefficient of the glassy coating then can lead to tensile stresses and surface faults.

A content of from 0.2 to 1.6% by weight of the sum of these ingredients according to the invention, i.e. ΣNa₂O+K₂O+CaO+SrO+BaO+F+refining agents, guarantees that the desired residual glass fraction in the glass-ceramic and the glassy coating on the surface are formed. A higher content of these ingredients than 1.6% by weight is to be avoided because otherwise the thermal expansion coefficient increases and the required temperature difference resistance is not achieved.

The described coating structure can be produced during the ceramicizing with an about 0.5 to 2.5 μm thick glass surface coating and keatite mixed crystals in the interior of the glass-ceramic, when nuclei formation of Zr/Ti-containing crystal nuclei is performed at a temperature of from 650 to 760° C., the crystallization of the high quartz mixed crystal phase is performed at a temperature of from 760 to 850° C. and the conversion to the keatite mixed crystal phase is performed at maximal temperatures of from 1000 to 1200° C., wherein the heating rate at the conversion temperature should be greater than 10 K/min and the holding time at the maximum temperature amounts to less than 40 minutes.

The temperature maximum of the manufacturing process is at temperatures from 1000 to 1200° C. The conversion into the translucent or opaque cooking surface with a light transmission of under 15% occurs at these temperatures.

The heating rate and the holding time at the maximum temperature are selected so that the desired translucency and color shade are produced.

The maximum temperature during production is limited to values of at most 1150° C. during the making of a colored translucent cooking surface. This method of the invention produces a translucent glass-ceramic material, which is suitable especially for radiant heating and light diode indicators. It is characterized by a transmission of at least 2% at 700 nm, measured for a 4 mm thick plate. Because of that it is guaranteed that the radiantly heated bodies are observable during usage. Also signaling devices with light emitting diodes may be made. The transmission at 700 nm for a 4 mm thick sample is under 2% in the case of opaque embodiments and the light transmission generally amounts to less than 0.1%.

In a preferred embodiment the glass-ceramic article providing the cooking surface has a composition, in % by weight on the basis of oxide content, of:

| Oxide | % by weight |
|---|---|
| Li₂O | 3.5-4.2 |
| Na₂O | 0-0.8 |
| K₂O | 0-0.4 |
| Σ Na₂O + K₂O | 0.2-1.0 |
| Σ CaO + SrO + BaO | 0-1.0 |
| ZnO | 0.8-2.2 |
| Al₂O₃ | 19.5-23 |
| SiO₂ | 65-70 |
| TiO₂ | 1.8-3.0 |
| ZrO₂ | 0.5-2.2 |

and at least one refining agent from the group consisting of As₂O₃, Sb₂O₃, SnO₂, CeO₂ or sulfate and/or chloride compounds, in a total amount of up to 0.8% by weight.

A glass with Li₂O, ZnO, Al₂O₃ and SiO₂ with the stated limits is the starting point for making the lattice structure of the translucent or opaque glass ceramic cooking surface according to the invention. These components are ingredients of high quartz mixed crystals and keatite mixed crystals. The comparatively narrow limits are necessary so that the desired lattice structure is formed. The Al₂O₃ content should amount to >19.5% by weight, because otherwise the high quartz mixed crystals are undesirably close to the surface. The Al₂O₃ content preferably amounts to less than 23% by weight, because a high Al₂O₃ content in the design of the melt can lead to undesired devitrification of mullite. From 0 to 1.5 percent by weight of MgO and from 0 to 1.0 percent by weight of P₂O₅ can be included as additional components. The addition of the alkali metal oxides Na₂O and K₂O as well as the alkaline earth metal oxides CaO, SrO and BaO during manufacture improves the meltability and the devitrification behavior of the glass. The amounts of these ingredients are limited because these ingredients essentially remain substantially in the residual glass phase of the glass ceramic and increase the thermal expansion in undesirable ways when their contents are too high. The stated minimum amounts of the alkali and/or alkaline earth oxides are required so that the lattice structure according to the invention can form with the glassy surface coating. The TiO₂ content amounts to between 1.8 and 3 percent by weight, the ZrO₂ content amounts to between 0.5 and 2.2 percent by weight. TiO₂ and ZrO₂ function as nucleation agents. At least one refining agent, for example As₂O₃, Sb₂O₃, SnO₂, CeO₂, sulfate and/or chloride compounds, is added in a total amount of up to 0.8 percent by weight.

The water content of the starting glass is usually between 0.01 and 0.06 mol/l, depending on the choice of raw materials for the batch and of process conditions in the melt. Fe₂O₃ is introduced as an impurity in amounts of from about 100 to 400 ppm by the conventional raw material batches used in the glass industry.

In an especially preferred embodiment the translucent or opaque colored glass-ceramic article is characterized by a high crystallinity in the interior of the glass-ceramic with a residual glass phase fraction of less than 6% and the following composition, in percent by weight based on oxide content, of:

| Oxide Ingredient | % by weight |
|---|---|
| Li₂O | 3.5-4.2 |
| Na₂O | 0-0.7 |
| K₂O | 0-0.3 |
| Σ Na₂O + K₂O | 0.2-0.8 |
| MgO | 0.5-1.2 |
| Σ CaO + SrO + BaO | 0-0.6 |
| ZnO | 1.0-2.0 |
| Al₂O₃ | >19.8-22 |
| SiO₂ | 67-69 |
| TiO₂ | 2.0-3.0 |
| ZrO₂ | 1.0-2.0 |
| P₂O₅ | 0-0.8 |

and at least one refining agent from the group consisting of As₂O₃, Sb₂O₃, SnO₂, CeO₂ or sulfate and/or chloride compounds, in a total amount of up to 0.8% by weight, and

wherein the content of enriched ingredients in the residual glass phase in the interior of the glass-ceramic and in the glassy surface layer of ΣNa₂O+K₂O+CaO+SrO+BaO+F+refining agents is from 0.2 to 1.3% by weight.

The environmental problems occur when arsenic and/or antimony oxide are used for chemical refining agents, also when barium oxide is added in small amounts. Barium-oxide-containing raw material, especially when they are water-soluble such as barium chloride and barium nitrate, is toxic and requires special precautionary measures. It is advantageously possible to avoid addition of BaO to the glass-ceramic except in unavoidable trace amounts due to impurities in other ingredients.

The content of the refining agents, for example As₂O₃, Sb₂O₃, SnO₂, should be less than 0.6 percent by weight in order to provide an environmentally friendly melt and refining. Preferably less than 0.4 percent by weight of SnO₂ is used as the refining agent without As₂O₃ and Sb₂O₃. The cooking surface is thus technically free of As₂O₃ and Sb₂O₃, except for unavoidably trace impurities. For applications with the most exacting requirements for bubble quality it is advantageous to perform the refining of the starting glass at high temperatures above 1 670° C., preferably greater than 1 750° C. The high temperature refining minimizes the required content of refining agents.

To obtain a high temperature difference resistance it has been shown that it is good, when the average grain size of the keatite mixed crystals in the interior of the glass-ceramic article is from 0.1 to 1.0 μm, preferably from 0.15 to 0.6 μm. The upper limit of this particle size range is understandable because undesirably large micro-stresses arise with larger average grain sizes, also with gross structure. The average grain size should not be less than 0.1 μm, because otherwise light scattering and the resulting translucency and/or opacity are not sufficient in order to optimize the design of the colors of the glass-ceramic material when viewing the cooking surface. Also the grain size range of 0.1 to 1.0 μm has been shown to achieve high resistance σ_{g} to the standard damage in practice.

To achieve a high temperature difference resistance the resistance σ_{g} to the standard damage in practice should be large and the thermal expansion coefficient α should be small. E-modulus and Poisson number can only be influenced to a small extent by the composition and the methods of manufacture. Thus it has proven to be advantageous when the thermal expansion of the glass ceramic between room temperature and 700° C. is less than 1.1·10⁻⁶/K, preferably less than 1.0·10⁻⁶/K.

The hydrolytic resistance of the cooking surfaces according to DIN ISO 719 is class 1, the alkali resistance according to DIN ISO 695 is at least class 2 and the acid resistance according to DIN 12116 is at least class 3. The glass-ceramic articles according to the invention that provide the cooking surfaces also fulfill high specifications in usage, for example regarding the action of chemically aggressive food or cleaning agents and combustion gas in gas cooking units because of their good chemical resistance to water, acids and alkali. This is e.g. the case with food materials, when they contain acid or when they form aggressive decomposition products when food boils over. Attack by sulfuric acid-containing combustion gas occurs in gas cooking units, when the combustion gas is below the dew point of sulfuric acid.

It is especially advantageous for resistance to chemical attack when the thickness of the glassy surface layer, which renders the glass-ceramic passive to chemical attack, increases during conversion of the glass-ceramic from the high quartz mixed crystal phase to the keatite mixed crystal phase due to selection of the composition and processing conditions. While the thickness of the glassy surface layer usually decreases during conversion of the glass-ceramic, surprisingly the opposite behavior was discovered in the case of the above-described preferred compositions.

Preferably the infrared transmission of a 4 mm thick sample measured at 1600 nm should be greater than 70%. Higher cooking rates are obtained because of that. This results when the colored oxides, which absorb infrared, such as CoO, Fe₂O₃, NiO, are limited.

The translucent or opaque colored glass-ceramic article providing the cooking surface is made in different color shades according to the requirements and wishes of the market. When a high white value of L*>83 in the Lab system is desired, the content of impurities, here especially V₂O₅, MoO₃, CoO and NiO, must be limited to an extremely low value during the manufacture of the cooking surface. The total content of colored impurities should be <30 ppm and the content of V₂O₅<10 ppm, MoO₃<10 ppm, CoO<10 ppm and NiO<20 ppm.

In contrast when colored shades are desired, usual coloring ingredients such as V—, Cr—, Mn—, Ce—, Fe—, Co—, Mo—, Cu—, Ni—and Se—Cl compounds, are used in order to reach certain color locations in the a Lab system. The addition of CeO₂, MnO₂, Fe₂O₃ individually or in combination as coloring ingredients in a total amount up to 0.5% by weight has proven successful for production of a beige color shade. The preferred color coordinates measured in incident light in the Lab system are an L* of 70 to 87, a* of −5 to 2 and b* of 0 to 10. Co and/or NiO are preferred as principal ingredients for producing glass-ceramic articles with blue color shades in incident light. For this purpose the sum of the CoO amount and the NiO amount should be from 0.2 to 1.0% by weight. In order to counteract the reddish tinge produced by CoO addition, other coloring agent, like V₂O₅ or MoO, can be added in small amount of about 80 ppm. The preferred color shades correspond to the following color coordinates in the Lab system: L* of 15 to 45, a* of 0 to 30 and b* of −50 to −10. Glass-ceramic articles with a dark gray color in incident light are also preferred and contain 300 to 1500 ppm V₂O₅ as principal coloring ingredient. This latter color shade has the following color coordinates in the Lab system: L* of 25 to 45, a* of —3 to 10 and b* of —15 to 0. When a light gray color shade is desired, V₂O₅ is used as the principal coloring ingredient in an amount of from 30 to 300 ppm and in the Lab system the preferred color coordinates are the following: L* of 45 to 65, a* of −3 to 10 and b* of −15to 0.

Preferably the translucent or opaque colored glass-ceramic article providing the cooking surface has a planar or three-dimensional geometry and is used in a cooking system heated by a radiant heating body, halogen radiator, gas, induction or direct resistance heating, which is also part of the invention.

The invention will now be illustrated with the help of the following examples, whose details should not be considered as limiting the appended claims.

### EXAMPLES

Table I lists individual base glass compositions and comparative base glass compositions that are the starting points for making the exemplary glass-ceramic articles of the invention and comparative glass-ceramic articles. The compositions of the starting glasses that were ceramicized to make the glass-ceramic articles comprise the base glass compositions plus various different coloring components and are listed in Table II.

TABLE I
BASE GLASS COMPOSITIONS OF THE INVENTION
AND COMPARATIVE BASE GLASS COMPOSITIONS
ON AN OXIDE BASIS

| Oxide | Base Glass of the | Comparative Base |
|---|---|---|
| Ingredient | Invention, Wt. % | Glass, Wt. % |
| Li₂O | 3.8 | 3.7 |
| Na₂O | 0.4 | 0.5 |
| K₂O | 0.2 | 0.1 |
| MgO | 1.0 | 0.5 |
| BaO | — | 2.0 |
| ZnO | 1.7 | 1.7 |
| Al₂O₃ | 21.2 | 22.1 |
| SiO₂ | 67.5 | 63.8 |
| TiO₂ | 2.5 | 2.4 |
| ZrO₂ | 1.7 | 1.7 |
| Sb₂O₃ | — | 1.5 |

TABLE II
STARTING GLASS COMPOSITIONS OF THE INVENTION AND
COMPOSITIONS FOR COMPARATIVE GLASSES BASED ON THE
BASE GLASS COMPOSITIONS ON AN OXIDE BASIS

| | Glass No. | | | | | |
|---|---|---|---|---|---|---|
| | 1 | 2 | 3 | 4 | 5 | Comparative |
| Base glass, wt. % | 99.58 | 99.50 | 99.73 | 99.76 | 99.19 | |
| As₂O₃, wt. % | 0.42 | 0.44 | — | — | — | — |
| SnO₂, wt. % | — | — | 0.20 | 0.23 | 0.23 | — |
| CeO₂, wt. % | — | 0.061 | — | — | — | — |
| V₂O₅, wt. % | — | — | 0.066 | 0.012 | 0.007 | — |
| CoO, wt. % | — | — | — | — | 0.57 | — |
| Tg, ° C. | 676 | 681 | 677 | 671 | 666 | 679 |
| V_{A}, ° C. | 1314 | 1310 | 1314 | 1312 | 1303 | 1295 |
| Density, g/cm³ | 2.436 | 2.447 | 2.436 | 2.436 | 2.450 | 2.495 |
| α_{20/300}, 10⁻⁶/K | 3.97 | 3.94 | 3.89 | 3.90 | 3.88 | 4.10 |
| DTA-peak Temp.* | | | | | | |
| high quartz, ° C. | 834 | 832 | — | — | — | — |
| keatite, ° C. | 1020 | 1004 | — | — | — | — |

*heating rate 5° C./min.

High temperature refining was used to achieve good bubble quality in the melt of examples 1 and 2 according to the invention in table II . The starting glasses were fused using raw materials for sintered silica glass that are standard in the glass industry in a high frequency heated 4 l vessel at a temperature of about 1750° C. and, after that the batch was completely melted, refined at about 1950° C. Prior to pouring the glass melt out the temperature was lowered to about 1750° C. The starting glasses of the other examples were melted at a temperature of about 1650° C. and refined. The resulting glass pieces starting at about 680° C. were cooled in a cooling oven to room temperature and divided into the pieces of the size required for the tests.

The glasses typically contain from 180 to 260 ppm of Fe₂O₃ because of the presence of raw material impurities. The water content amounted to about 0.04 mol/l.

The peak temperature during differential thermal analysis (DTA) for crystallization of high quartz mixed crystals and keatite mixed crystals was measured in addition to the following glass properties: transformation temperature, Tg; processing temperature, VA; density and thermal expansion coefficient between 20 and 300° C.

The above-described glasses were ceramicized by the following method: Plate-shaped green glass bodies were brought from room temperature to a temperature of 650° C. with a heating rate of 25 K/min and then heated with a heating rate of 14 K/min to a crystal nuclei or seed formation temperature of 750° C. After the nucleation process the sample was heated further to a temperature of 840° C. with a heating rate of 8 K/min and held there for about 35 minutes for crystallization of the high quartz mixed crystals. Subsequently the glass-ceramic was heated to a maximum temperature with a heating rate of about 15 K/min and the conversion to the glass-ceramic article with the keatite mixed crystal phase took place. Then the glass-ceramic was cooled to 810° C. with a cooling rate of 15 K/min and further in an uncontrolled fashion to room temperature according to the characteristic curve for the oven. Tables III and IV show the conversion temperature and the holding times and the measured properties for the glass-ceramic articles that were obtained.

The samples were polished on both side for the transmission measurements in transmitted light and the color measurements with reflected light. Because of that the sample thickness was of course slightly less than 4 mm.

White values L* and color parameters a* and b* were measured with a measuring unit of Datacolor, called Mercury 2000, in remission with reflected light with standard light D65 and standard light C against a black background.

The test of selected exemplary cooking surfaces according to the invention for temperature difference resistance occurred with the assistance of information regarding the typical load situation for cooking applications. A large piece cut out from the 4 mm thick glass-ceramic plate to be tested (usually a square piece with dimensions 250 mm×250 mm) is horizontally oriented after usage-typical surface damage has been produced in it. The underside of the glass-ceramic plate is heated by a standard circular radiant heating body, as is typical in a cooking range, and the temperature is increased. The generally increasing surface temperature of the glass-ceramic plate measured during the heating process on the upper side is measured and of course at the hottest point resulting from the heating by the heating system. The critical region of the plate edge to be tested in regard to temperature different resistance has an unheated minimum width—measured as minimum spacing between the plate outer edges and the inner boundary of the laterally insulated edge of the radiating body—corresponding to the critical cooking range conventional heated body positioning. During the heating process the unheated outer edge is under tangential tensile stress. That temperature at the above-described measuring position, at which the glass-ceramic plate breaks because of the tensile stresses, is designated as the characteristic value for the temperature difference resistance or TUF. As shown from table III TUF values between 760° C. to over 800° C. are reached.

The impact resistance was measured on selected exemplary cooking surfaces by the falling ball test according to DIN 52306. A square test sample (100 mm×100 mm in size) cut from the 4 mm thick glass-ceramic plate is placed on a test frame and a 200 g heavy steel ball is dropped on the center of the sample. The filling height is increased stepwise until the dropping ball breaks the sample. Because of the statistical character of the impact strength the testing is performed for a series of about 10 samples and the average value of the measured breaking height is determined. The breaking heights were measured and found to be between 25 cm and 39 cm (see Table III).

As seen from Table III and IV, the color shades of the starting glass that is ceramicized are controlled by measured addition of color-imparting ingredients and by selection of the conversion conditions, i.e. especially by variation of the holding time and the maximum temperature.

Phase content and crystallite size of the keatite mixed crystal phase and the secondary phases were determined by means of X-ray diffraction. The keatite phase content amounted to more than 91% in the glass-ceramic articles providing the cooking surface according to the invention. The average crystallite size fluctuated between 150 and 171 nm.

The Li-concentration-reduction depth stated in Table III was determined by means of the surface layer depth profile of the Li concentration determined with the SIMS method. This depth corresponds to the distance from the surface to the depth at which the Li concentration is half of its bulk value. The Li-concentration-reduction depth is a measure of the thickness of the glassy passivated surface layer. An increased concentration of Na and K is observed at the Li-con-centration-reduction depth. The Li-concentration-reduction depth (thickness of the glassy passivated surface layer) was measured in the glasses 3, 4 and 5 after crystallization of the high quartz mixed crystal glass-ceramic article. The thickness is between 400 and 500 nm and thus clearly below the thickness after conversion to the keatite mixed crystal glass-ceramic article.

The good chemical resistance of the glass-ceramic article according to the invention is apparent in Table III. The measurements of the standard sample with the originally ceramicized surface for acid resistance (DIN 12116), alkali resistance (DIN ISO 695) and hydrolytic resistance (DIN ISO 719) take place in stages after class 1. After measurement the surfaces of the samples were polished and because of that the passivating glassy surface layer was removed. A new measurement of the chemical resistance of the exposed bulk material produces poorer values for the critical acid attack parameter.

The linear thermal expansion coefficient, α_{20/700}, the density and the E-modulus are additional measured properties.

The comparative glass (Table I) has a higher content of components, which enrich the residual glass phase, of ΣNa₂O+K₂O+BaO+refining agent, Sb₂O₃=4.1 wt. %. The linear thermal expansion coefficient after conversion into the keatite mixed mixed crystal glass-ceramic made from the comparative glass is comparatively high at 1.3×10⁻⁶/K (Table III, example 3). The resulting low temperature difference resistance of about 500° C. makes the material unsuitable for cooking surfaces with radiant heating.

TABLE III
CONVERSION CONDITIONS, COLORS AND PROPERTIES OF
TRANSLUCENT KEATITE MIXED CRYSTAL GLASS-CERAMICS

| | Example | | | |
|---|---|---|---|---|
| | 1 | 2 | 3 | 4 |
| Glass No. | 1 | 2 | comparative | 3 |
| | | | glass | |
| Conversion Tₘₐₓ, ° C. | 1090 | 1094 | 1000 | 1080 |
| Holding time t at Tₘₐₓ, | 6 | 6 | 6 | 5 |
| min | | | | |
| Appearance | White | Beige | White | Dark grey |
| | translucent | translucent | translucent | translucent |
| Transmission (D65/2°) | | | | |
| Sample thickness, mm | 3.6 | 3.6 | 4.0 | 3.2 |
| Light transmission, τ_{vis,} % | 6.0 | 5.4 | 2.6 | 0.2 |
| 700 nm % | 15.8 | 16.0 | — | 7.0 |
| 1600 nm % | 73.1 | 73.2 | 69.5 | 81.4 |
| REMISSION (D65/10°) | | | | |
| Sample thickness | 3.6 | 3.6 | 4.0 | 3.6 |
| L* | 86.8 | 84.4 | 77.6 | 33.9 |
| a* | −2.0 | −2.1 | — | 1.7 |
| b* | −3.6 | 2.5 | — | −6.5 |
| α_{20/700}, 10⁻⁶/K | +0.96 | +0.99 | +1.3 | +0.89 |
| KMK phase content, % | >95 | >95 | 83 | 95 |
| KMK crystallite size, nm | 160 | 150 | 170 | 171 |
| Secondary phases (<5%) | ZrTiO₄ | ZrTiO₄ | ZrTiO₄ | ZrTiO₄ |
| Trace amounts | ZrSiO₄, | ZrSiO₄, | | ZrSiO₄ |
| | ZnAl₂O₄ | ZnAl₂O₄ | | |
| Density, g/cm³ | 2.509 | 2.516 | — | 2.512 |
| E-modulus, GPa | 87.5 | 87.9 | 87.8 | 90.4 |
| Li-concentration- | 2040 | 1880 | 1500 | — |
| reduction depth, nm | | | | |
| TUF, ° C. | >800 | — | about 500 | 760 |
| Impact strength, | — | — | — | 39 |
| average, cm | | | | |

Chemical Resistances

| | | | | |
|---|---|---|---|---|
| Acid | | | | |
| surface layer, mg/dm² | <0.3 | <0.3 | — | — |
| DIN class | 1 | 1 | | |
| bulk, mg/dm² | 1.3 | 1.1 | | |
| DIN class | 2W | 2W | | |
| Alkali | | | | |
| surface layer, mg/dm² | 61 | 61 | | — |
| DIN class | A1 | A1 | | |
| bulk, mg/dm² | 61 | 65 | | |
| DIN class | A1 | A1 | | — |
| Water, μg Na₂O/g | 9 | 10 | | — |
| (on glass grit), hydrol. | HGB1 | HGB1 | | |
| class | | | | |

| | Example | | | |
|---|---|---|---|---|
| | 5 | 6 | 7 | 8 |
| Glass No. | 3 | 3 | 4 | 4 |
| Conversion Tₘₐₓ, ° C. | 1085 | 1090 | 1045 | 1090 |
| Holding time t at Tₘₐₓ, | 0 | 15 | 5 | 5 |
| min | | | | |
| Appearance | Dark grey | Dark grey | Light grey | Light grey |
| | translucent | opaque | translucent | Translucent |
| Transmission (D65/2°) | | | | |
| Sample thickness, mm | 3.6 | 3.2 | 3.6 | 3.6 |
| Light transmission, τ_{vis,} % | 0.1 | <0.1 | — | 4.5 |
| 700 nm % | 4.3 | 1.6 | 30.2 | 27.8 |
| 1600 nm % | 77.8 | 77.6 | 83.7 | 83.5 |
| REMISSION (D65/10°) | | | | |
| Sample thickness | 3.6 | 3.6 | 3.6 | 3.6 |
| L* | 35.8 | 39.7 | 58.3 | 48.9 |
| a* | 1.9 | 2.3 | −0.1 | 1.1 |
| b* | −6.0 | −6.8 | −7.1 | −7.5 |
| α_{20/700}, 10⁻⁶/K | +0.90 | +0.92 | +0.89 | +0.95 |
| KMK phase content, % | >95 | 91 | >95 | >95 |
| KMK crystallite size, nm | 160 | 162 | 160 | 167 |
| Secondary phases (<5%) | ZrTiO₄ | ZrTiO₄ | ZrTiO₄ | ZrTiO₄ |
| Trace amounts | ZnAl₂O₄ | ZnAl₂O₄ | ZnAl₂O₄, | ZrSiO₄ |
| | ZrSiO₄, | ZrSiO₄, | ZrSiO₄ | |
| Density, g/cm³ | 2.512 | 2.513 | 2.513 | 2.513 |
| E-modulus, GPa | 90.4 | 90.1 | 90.3 | 90.3 |
| Li-concentration- | ˜2000 | — | ˜2300 | — |
| reduction depth, nm | | | | |
| TUF, ° C. | 785 | 770 | 780 | 780 |
| Impact strength, | 35 | — | 25 | |
| average, cm | | | | |

Chemical Resistances

| | | | | |
|---|---|---|---|---|
| Acid | | | | |
| surface layer, mg/dm² | 0.5 | — | 0.6 | — |
| DIN class | 1 | | 1 | |
| bulk, mg/dm² | 1.3 | | 1.1 | |
| DIN class | 2W | | 2W | |
| Alkali | | — | | |
| surface layer, mg/dm² | 57 | | 64 | — |
| DIN class | A1 | | A1 | |
| bulk, mg/dm² | 41 | | 40 | |
| DIN class | A1 | | A1 | — |
| Water, μg Na₂O/g | 9 | — | 8 | |
| (on glass grit), hydrol. | HGB1 | | HGB1 | |
| class | | | | |

| | Example | | |
|---|---|---|---|
| | 9 | 10 | 11 |
| Glass No. | 5 | 5 | 5 |
| Conversion Tₘₐₓ, ° C. | 1070 | 1075 | 1090 |
| Holding time t at Tₘₐₓ, | 5 | 0 | 15 |
| min | | | |
| Appearance | Blue | Blue | Blue |
| | translucent | translucent | translucent |
| Transmission (D65/2°) | | | |
| Sample thickness, mm | 3.6 | 3.6 | 3.2 |
| Light transmission, τ_{vis,} % | 0.1 | 0.1 | 0.1 |
| 700 nm % | 25.6 | 21.0 | 7.6 |
| 1600 nm % | 6.4 | 5.8 | 7.7 |
| REMISSION (D65/10°) | | | |
| Sample thickness | 3.6 | 3.6 | 3.6 |
| L* | 28.6 | 29.0 | 33.0 |
| a* | 11.0 | 11.7 | 17.5 |
| b* | −23.3 | −24.7 | −35.6 |
| α_{20/700}, 10⁻⁶/K | +0.84 | +0.85 | +0.85 |
| KMK phase content, % | 98 | 89 | 91 |
| KMK crystallite size, nm | 173 | 168 | 168 |
| Secondary phases (<5%) | ZrTiO₄ | ZrTiO₄ | ZrTiO₄ |
| Trace amounts | ZrSiO₄ | | ZnAl₂O₄, |
| | | | ZrSiO₄ |
| Density, g/cm³ | 2.514 | 2.515 | 2.5183 |
| E-modulus, GPa | 90.5 | 87.0 | 90.4 |
| Li-concentration- | — | 1890 | — |
| reduction depth, nm | | | |
| TUF, ° C. | 786 −> 850 | 850 | 820 |
| Impact strength, | 38 | 33 | 31 |
| average, cm | | | |

Chemical Resistances

| | | | |
|---|---|---|---|
| Acid | | | |
| surface layer, mg/dm² | — | 0.4 | — |
| DIN class | | 1 | |
| bulk, mg/dm² | | 1.2 | |
| DIN class | | 2W | |
| Alkali | — | | |
| surface layer, mg/dm² | | 36 | — |
| DIN class | | A1 | |
| bulk, mg/dm² | | 41 | |
| DIN class | | A1 | |
| Water, μg Na₂O/g | | 10 | — |
| (on glass grit), hydrol. | — | HGB1 | |
| class | | | |

TABLE IV
CONVERSION AND COLORS OF TRANSLUCENT COLORED
KEATITE MIXED CRYSTAL GLASS-CERAMICS MADE
FROM THE BASE GLASS COMPOSITIONS DOPED WITH
THE STATED COLORING INGREDIENTS (Color measurements:
Remission, Light Standard C, 2° Measurement
angle)

| | Glass Nr. | | | | | | | | |
|---|---|---|---|---|---|---|---|---|---|
| | 6 | 7 | 8 | 9 | 10 | 11 | 12 | 13 | 14 |
| SnO₂ | 0.25 | 0.25 | 0.25 | 0.25 | 0.25 | 0.25 | 0.25 | 0.25 | 0.25 |
| CoO | 0 | 0 | 0.25 | 0.25 | 0.5 | 0.5 | 0.01 | 0 | 0 |
| V₂O₅ | 0 | 0.007 | 0 | 0.007 | 0 | 0.007 | 0.01 | 0.003 | 0.007 |
| CeO₂ | 0 | 0 | 0 | 0 | 0 | 0 | 0 | 0.1 | 0 |
| MnO₂ | 0 | 0 | 0 | 0 | 0 | 0 | 0 | 0 | 0.6 |
| MoO₃ | 0 | 0 | 0 | 0 | 0 | 0 | 0 | 0 | 0.004 |

Conversion Tₘₐₓ = 1100° C., 5 min holding time

| | Example | | | | | | | | |
|---|---|---|---|---|---|---|---|---|---|
| | 12 | 15 | 18 | 21 | 24 | 27 | 30 | 33 | 36 |
| L* | 68.8 | 53.2 | 35.4 | 33.2 | 30.9 | 31.2 | 58.1 | 39.2 | 45.1 |
| a* | −6.2 | 2.4 | 27.7 | 17.5 | 28.7 | 21.5 | −0.5 | 12.4 | 2.0 |
| b* | −4.5 | −11.0 | −42.0 | −29.4 | −41.1 | −33.4 | −6.3 | −24.6 | −11.3 |

Conversion Tₘₐₓ = 1100° C., 15 min holding time

| | Example | | | | | | | | |
|---|---|---|---|---|---|---|---|---|---|
| | 13 | 16 | 19 | 22 | 25 | 28 | 31 | 34 | 37 |
| L* | 77.4 | 59.7 | 41.2 | 37.7 | 33.0 | 35.2 | 66.4 | 45.3 | 55.0 |
| a* | −4.8 | 2.5 | 28.9 | 19.6 | 30.3 | 24.9 | 0.3 | 12.8 | 1.9 |
| b* | −1.1 | −9.8 | −45.4 | −33.5 | −44.0 | −38.9 | −5.3 | −26.0 | −12.2 |

Conversion Tₘₐₓ = 1100° C., 20 min holding time

| | Example | | | | | | | | |
|---|---|---|---|---|---|---|---|---|---|
| | 14 | 17 | 20 | 23 | 26 | 29 | 32 | 35 | 38 |
| L* | 82.3 | 64.3 | 43.5 | 43.7 | 40.4 | 37.8 | 72.6 | 47.7 | 64.9 |
| a* | −3.6 | 2.4 | 26.7 | 19.5 | 32.2 | 24.8 | 0.5 | 12.2 | 1.5 |
| b* | 1.3 | −7.4 | −45.1 | −36.7 | −50.6 | −40.9 | −2.0 | −26.3 | −9.0 |

The disclosure in German Patent Application 10 2004 024 583.5-45 of May 12, 2004 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a translucent or opaque colored glass-ceramic article providing a cooking surface and its uses, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

1. A translucent or opaque colored glass-ceramic article providing a cooking surface, said colored glass-ceramic article having
an adjustable light transmission in a visible range under 15%, as measured for a 4 mm sample thickness;
a crack-free or flaw-free upper surface with an impact resistance of greater than 18 cm breaking height, as tested with a 200 g steel ball in a falling ball test;
a temperature difference resistance (TUF) of greater than 500° C.;
a high crystallinity with keatite mixed crystals as principal crystal phase in an interior of the glass-ceramic article and with a residual glass phase fraction of less than 8% by weight;
a glassy surface layer, which is substantially free of high quartz mixed crystals, from 0.5 to 2.5 μm thick and which inhibits chemical reactions; and
a content of enriched ingredients in the residual glass phase in the interior of the glass-ceramic and in the glassy surface layer of ΣNa₂O+K₂O+CaO+SrO+BaO+F+refining agents of from 0.2 to 1.6% by weight.

2. The glass-ceramic article as defined in claim 1, wherein the temperature difference resistance (TUF) is greater than 700° C.

3. The glass-ceramic article as defined in claim 1, having a transmission of at least 2% at 700 nm, as measured with said 4-mm sample thickness.

4. The glass-ceramic article as defined in claim 1, having a composition, in percent by weight on an oxide basis, of:

| Oxide Ingredient | % by weight |
|---|---|
| Li₂O | 3.5-4.2 |
| Na₂O | 0-0.8 |
| K₂O | 0-0.4 |
| Σ Na₂O + K₂O | 0.2-1.0 |
| MgO | 0-1.5 |
| Σ CaO + SrO + BaO | 0-1.0 |
| ZnO | 0.8-2.2 |
| Al₂O₃ | 19.5-23 |
| SiO₂ | 65-70 |
| TiO₂ | 1.8-3.0 |
| ZrO₂ | 0.5-2.5 |
| P₂O₅ | 0-1.0 |

and at least one refining agent from the group consisting of As₂O₃, Sb₂O₃, SnO₂, CeO₂ or sulfate and/or chloride compounds, in a total amount of up to 0.8% by weight.

5. The glass-ceramic article as defined in claim 1, wherein the residual glass phase portion is less than 6%, said crystallinity is higher in the interior and with a composition, in percent by weight on an oxide basis, of:

| Oxide Ingredient | % by weight |
|---|---|
| Li₂O | 3.5-4.2 |
| Na₂O | 0-0.7 |
| K₂0 | 0-0.3 |
| Σ Na₂O + K₂O | 0.2-0.8 |
| MgO | 0.5-1.2 |
| Σ CaO + SrO + BaO | 0-0.6 |
| ZnO | 1.0-2.0 |
| Al₂O₃ | >19.8-22 |
| SiO₂ | 67-69 |
| TiO₂ | 2.0-3.0 |
| ZrO₂ | 1.0-2.0 |
| P₂O₅ | 0-0.8 |

and at least one refining agent from the group consisting of As₂O₃, Sb₂O₃, SnO₂, CeO₂ or sulfate and/or chloride compounds, in a total amount of up to 0.8% by weight, and
wherein said content of said enriched ingredients in the residual glass phase in the interior of the glass-ceramic and in the glassy surface layer of ΣNa₂O+K₂O+CaO+SrO+BaO+F+refining agents is from 0.2 to 1.3% by weight.

6. The glass-ceramic article as defined in claim 1, free of BaO, except for unavoidable trace impurities of said BaO.

7. The glass-ceramic article as defined in claim 1, containing at least one refining ingredient in an amount less than 0.6% by weight and wherein said at least one refining ingredient is selected from the group consisting of As₂O₃, Sb₂O₃ and SnO₂.

8. The glass-ceramic article as defined in claim 1, containing SnO₂ for refining in an amount of less than 0.4% by weight and technically free of As₂O₃ and Sb₂O₃.

9. The glass-ceramic article as defined in claim 1, wherein the keatite mixed crystals in the interior have an average grain size of about 0.1 to 1.0 μm.

10. The glass-ceramic article as defined in claim 9, wherein said average grain size is from about 0.15 to 0.6 μm.

11. The glass-ceramic article as defined in claim 1, having a thermal expansion coefficient less than 1.1·10⁻⁶/K between room temperature and 700° C.

12. The glass-ceramic article as defined in claim 11, wherein said thermal expansion coefficient is less than 1.0·10⁻⁶/K

13. The glass-ceramic article as defined in claim 1, having a hydrolytic resistance of class 1, an acid resistance of at least class 3 and an alkali resistance of at least class 2.

14. The glass-ceramic article as defined in claim 1, having an infrared transmission greater than 70%, as measured with said 4 mm sample thickness at 1600 nm.

15. The glass-ceramic article as defined in claim 1, having an L* value >83 in the Lab system.

16. The glass-ceramic article as defined in claim 1, further comprising at least one color-imparting ingredient.

17. The glass-ceramic article as defined in claim 16, wherein said at least one color-imparting ingredient is selected from the group consisting of V—, Cr—, Mn—, Ce—, Fe—, Co—, Mo—, Cu—, Ni—and Se—Cl—compounds.

18. The glass-ceramic article as defined in claim 1, further comprising CeO₂, MnO₂ and/or Fe₂O₃ as coloring ingredient in an amount up to 0.5 percent by weight for adjustment of a beige color shade.

19. The glass-ceramic article as defined in claim 1, further comprising CoO and/or NiO in an amount for setting a blue color shade and wherein a sum total amount of said CoO and said NiO present is from 0.2 to 1.0 percent by weight.

20. The glass-ceramic article as defined in claim 17, containing from 300 to 1500 ppm of V₂O₅ in an amount sufficient to adjust or set a dark green color shade.

21. The glass-ceramic article as defined in claim 17, containing from 30 to 300 ppm of V₂O₅ in an amount sufficient to adjust or set a bright gray color shade.

22. A cooking apparatus comprising a radiant heating body, a halogen radiator, a gas heating unit, an induction heating unit or a direct resistance heating device, said cooking apparatus comprising a translucent or opaque colored glass-ceramic article providing a cooking surface as defined in claim 1 and in a plane or three-dimensional shape geometry.
